(19) United States
(12) Patent Application Publication
(10) Pub. No.: US 2016/0042765 A1
(43) Pub. Date: Feb. 11, 2016

(54) MEDIA COMPOSITION WITH TIMING BLOCKS

(71) Applicant: Avid Technology, Inc., Burlington, MA (US)

(72) Inventor: Ranbir Saini, Edmonton (CA)

(21) Appl. No.: 14/451,641

(22) Filed: Aug. 5, 2014

(51) Int. Cl. G11B 27/036; G06F 3/0484

(52) U.S. Cl. CPC G11B 27/036; G06F 3/04847

(57) ABSTRACT

Timing blocks provide a way of defining sections of a media composition regardless of whether media for a section is present. Timing blocks have a start and end time within a composition, and may be represented within a separate track in a timeline display of a media composition system user interface. In text-driven workflows, the duration of a timing block may initially be based on the amount of text to be accommodated. The duration and position of a timing block within a sequence may be manipulated with the flexibility hitherto available only for media clip manipulations. Individual timing blocks of a composition may be assigned to different editors and worked on in parallel, independently of each other.

### BACKGROUND

The creation of time-based media compositions of any significant complexity usually involves several individuals and teams, each responsible for different aspects of a composition. For example, one team may be responsible for video, another for special effects, and others for each of music, voice, and sound effects. Such divisions are often reflected in the individual tracks of a multi-track media composition, with each of multiple concurrent tracks being provided by a different team or individual. In productions featuring different shooting locations, especially when in different countries, individual teams are often dedicated to a specific field location.

Further subdivision in the media creation workflow occurs when media compositions are produced for consumption on more than one platform, and by more than one type of audience. The production timescales of different media renditions also ranges widely, from large-scale theatrical releases which span years on the one hand, to news productions that may be required in a matter of minutes in response to breaking news.

To accommodate the diverse nature of media production environments, additional tools are needed to facilitate the division of labor, while maintaining overall project flexibility and coordination among all participants.

### SUMMARY

In general, the methods, systems, and computer program products described herein enable media producers to specify temporal divisions that cut across all the various media components of a media composition. Such timing blocks may define individual content items, such as stories in a news broadcast. Enabling each block to be worked on concurrently and independently of other blocks provides a flexible, time-efficient workflow.

In general, in one aspect, a method of editing a time-based media composition comprising a media track includes: running a first instance of a media composition software application having a user interface that includes a display of a timeline representation of the time-based media composition; within the timeline, providing a track for defining and representing a plurality of timing blocks, wherein each timing block of the plurality of timing blocks is defined by a start time and an end time, and provides a container for media content of the time-based media composition that falls within a temporal span defined by the start time and the end time of the timing block; and enabling a user of the first instance of the media composition software application to edit media content in a given timing block independently of media content in timing blocks of the plurality of timing blocks other than the given timing block.

Various embodiments include one or more of the following features. The timeline includes a plurality of media tracks, and the media content of the time-based media composition that falls within the temporal span of the timing block includes media within each of the plurality of media tracks. A given timing block of the plurality of timing blocks includes an audio track comprising a spoken passage of text and a time span of the given timing block based on a predetermined text reading rate is defined. A time span of a given timing block of the plurality of timing blocks is defined prior to placing media content within a portion of the time-based media composition corresponding to the timing block. Running a second instance of the media composition software application and enabling a user of the second instance of the media composition software application to edit media content in a timing block other than the given timing block concurrently with the enablement of editing of the media composition in the given timing block by the first-mentioned user. A portion of the media composition corresponding to the given timing block is locked for editing by a user other than the first-mentioned user. A graphical indication associated with a timing block is provided to indicate whether a user other than the first-mentioned user has locked the timing block to prevent other users from editing the timing block. The graphical indication includes information on an identity of the user other than the first-mentioned user. A graphical indications associated with a timing block are provided to indicate whether the timing block has been approved by a participant in the editing of the media composition, and/or whether the timing block includes empty space for which media content is lacking. The user is able to rearrange a temporal sequence of the plurality of timing blocks. A time span of a timing block of the plurality of timing blocks is automatically adjusted to conform to a time span of media content placed on a media track within the timing block. The user is able to adjust at least one of a start time and an end time of the given timing block.

In general, in another aspect, a computer program product comprises: a non-transitory computer-readable storage medium with computer program instructions encoded thereon, wherein the computer program instructions, when processed by a computer, instruct the computer to perform a method for editing a time-based media composition comprising a media track, the method comprising: running a first instance of a media composition software application having a user interface that includes a display of a timeline representation of the time-based media composition; within the timeline, providing a track for defining and representing a plurality of timing blocks, wherein each timing block of the plurality of timing blocks is defined by a start time and an end time, and provides a container for media content of the time-based media composition that falls within a temporal span defined by the start time and the end time of the timing block; and enabling a user of the first instance of the media composition software application to edit media content in a given timing block independently of media content in timing blocks of the plurality of timing blocks other than the given timing block.

In general, in a further aspect, a system for editing a time-based media composition comprising a media track includes: a memory for storing computer-readable instructions and a processor connected to the memory, wherein the processor, when executing the computer-readable instructions, causes the system to: run a first instance of a media composition software application having a user interface that includes a display of a timeline representation of the time-based media composition; within the timeline, provide a track for defining and representing a plurality of timing blocks, wherein each timing block of the plurality of timing blocks is defined by a start time and an end time, and provides a container for media content of the time-based media composition that falls within a temporal span defined by the start time and the end time of the timing block; and enable a user of the first instance of the media composition software application to edit media content in a given timing block independently of media content in timing blocks of the plurality of timing blocks other than the given timing block.

### BRIEF DESCRIPTION OF THE DRAWINGS

FIG. 1 is a diagrammatic screen shot of a user interface of a media composition application with timing blocks.

### DETAILED DESCRIPTION

When video editors and journalists work on creating the content for their media productions, they need the ability to divide up their media sequences into sections that align with the structure and/or content of the end product. Such high level divisions can represent a framework that reflects an overall architecture of a media composition. For example, in a feature film, initial planning activity may set the relative importance of various scenes, which may translate into the proportion of available time to be devoted to each scene. In other contexts, certain times may already be allotted for some sections, as in a news program, for example, in which national news, international news, sports, and other sections are assigned predetermined time spans. Once individual sections have been defined, the content planning and development of each individual section can be conducted with some degree of independence from the other sections. Furthermore, such separation into well-defined sections permits each section to be worked on concurrently by different teams or individuals, which can greatly speed up the time required to complete a production.

Timing blocks are introduced to address the need for flexible partitioning of media productions. Timing blocks refer to temporally defined portions of a media production, in which a section is defined by a start time and an end time. Such times may be specified in terms of an offset (frames, clock, edgecode, etc.) from the beginning of the media sequence. The blocks preferably cut across all the media and metadata that fall within the temporally defined boundaries of a timing block.

The definition of timing blocks may start with a determination of appropriate timing for various sections of a composition as determined by a person overseeing the project sequence, such as a producer, director, or cinematographer. This determination may be performed even in the absence of any media content. Each timing block may be given a label that may also provide for a description and direction from the project overseer, which may include assignment of the block to a particular user or group. Once the timing block sequence and durations have been defined, the parties responsible for production of each block adhere to the stipulated durations, tailoring their media accordingly. Alternatively, some media may be present before a timing block is defined, and the timing block may be defined to conform to the duration of such pre-existing media. For example, a news editor may have received a video interview that has already been edited down to an appropriate length for broadcast. A news producer may then specify a timing block that conforms to the video segment. In another example, the text of a news story item in a news rundown may be set first. A timing block would then be defined as a duration required to read the text on the air based on an established text reading rate.

The definition of a timing block may be provided with some flexibility. For example, if a block has been defined as lasting 3 minutes, but a video segment is received having a duration of 3 minutes and 10 seconds, the timing block may be extended automatically to conform to the video segment duration. Such conforming may be limited to a certain range, for example to plus or minus 5 to 20 seconds (or the corresponding number of frames) on either side of the predefined block duration.

Timing blocks provide a means of reorganizing and arranging a media composition in the absence of the media content itself. Such flexibility has not been possible with editing systems for which timing changes involve the manipulation of actual media clips themselves within a segment. Indeed, in many systems, it is not possible to edit media at temporal locations where there is an empty portion of the timeline present at an earlier time.

Non-linear editing systems, such as Media Composer® from Avid® Technology, Inc., of Burlington Mass., provide a graphical user interface for editors that includes a timeline representation of the media composition being work on. Typically, time is laid out in a horizontal direction, and a series of vertically stacked concurrent media and metadata tracks make up the timeline. The duration of each clip is represented by its horizontal length, and temporal position within the composition increases with time moving from left to right.

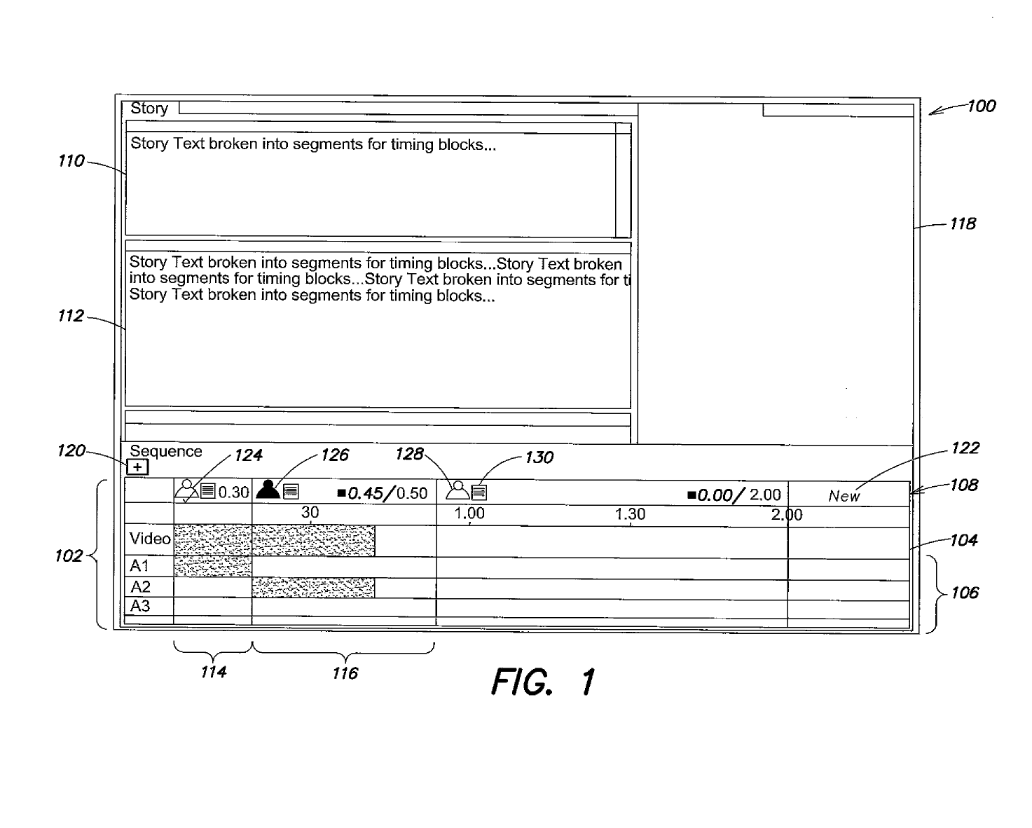

FIG. 1 shows such an interface 100 with timeline 102 comprising video track 104, and three audio tracks 106. Timing blocks are shown within separate track 108 at the top of the timeline. One or more windows in the upper portion of the interface show timing block content. In the example illustrated in FIG. 1, windows 110 and 112 show text content of timing blocks 114 and 116 respectively. Another pane in the interface may be reserved for playback, as shown at 118 in FIG. 1.

The user creates a new timing block by clicking in the timing block track to create an end point or start point of a new timing block. Button 120 at the left end of the timing block track provides another means of adding a new timing block, which may be placed at a temporal location based on the position of the play head, e.g., starting at the play head position, when the button is clicked. Alternatively, insertion of media content onto a portion of the timeline not currently spanned by a timing block (e.g., region 122), results in the automatic creation of a new block having a duration initially defined by the duration of the inserted media. If the new media item has text but the media is not yet present, the length required may be estimated from a standard read-rate.

Existing timing blocks may be adjusted by dragging their boundaries to the left (to an earlier time) or to the right (later time). Timing blocks may be deleted manually, or, if associated with a story segment that is deleted by a user, they may be deleted if the associated story is deleted.

When an editor is working on the content of a timing block, the block becomes locked for editing by others. When other editors view the timeline, an indication of the locked status appears in the timing block on the timeline, and it may also be possible to determine the identity of the editor currently working on the timing block, as well as to communicate with him/her either via a message or speaking via an audio or video link. An edit history of the block may also be available.

The collaborative editing workflows supported by timing blocks may also enable a team member to review a block and comment on it and/or approve it. Graphical or text indications in the timing block track may be used to provide this information. In the example shown in FIG. 1, icon 124 indicates approval of the corresponding timing block, icon 126 indicates the editor controlling the displayed user interface has a lock on the timing block, and icon 128 indicates that someone else has a lock for editing on the corresponding timing block.

Since a timing block may be defined independently of media content, the media that is added to the timing block may not have a duration that conforms to that of the timing block. If there is insufficient media, there will be a black space, and this can be flagged with an indication on the timeline, together with the duration of the black space. Conversely, if there is excess media, another form or color of indictor appears in the timeline, together with the duration of the excess material.

Timing blocks may prove especially valuable in the context of productions that start with textual content. Users may enter text directly into the timing block track after initiating a text entry dialog, such as by means of button 130. The button may indicate whether its corresponding timing block already contains some text. In addition to enabling direct text entry, the dialog enables users to specify a path/link to the text they wish to include. This may be especially useful when a large quantity of text is to be included since there is limited display space within the timing block track. For relatively small amounts of text, the text itself may appear within the timeline on the timing block track, or may pop up when the timing block is rolled over by a mouse or otherwise pointed to by the user.

The need for text-driven timing blocks may arise in a number of application contexts, as described now. News programs often start with a number of short text items that are assembled, prioritized, and broadcast within a short time. In most news contexts, a story is broken up into sections, each of which is assigned a timing block. A first section may include full-screen video of a news anchor speaking about a news event. A second section may show full-screen video footage of the event. In a third section, the anchor may reappear, with video footage continuing in a portion of the screen. As news stories unfold, editors constantly rearrange the items in the news rundown. When media is being received from onsite crews, it is often the case that the framework of the story is being generated before all the media has been received from the field. News editors are able to lay out and adjust the sequence and duration of stories using timing blocks, with a timing block assigned to each news story. As the media are received, the timing block is populated accordingly. Durations can be adjusted to fit the available media, either manually or via automatic synchronization. As new stories break, or priorities become altered, the editor may rearrange timing blocks to update the order of the items in the news rundown. Various graphical user interfaces are provided to facilitate rearrangement, including enabling an editor to click and drag blocks from one position to another in the timeline.

A second text-driven workflow benefitting from the use of timing blocks involves song creation. Lyrics entered as text are separately identified according to the artist who is to sing them, with the portions for each artist placed into separate timing blocks. Splitting up the workflow according to the singer-determined timing blocks enables the artists to fulfil their parts while working independently of each other.

Feature films may also be text-driven when they are based on a script, with different portions placed into different timing blocks. For example, when a scene is to comprise computer-generated imagery (CGI), the corresponding text may be placed into its own timing block, which is assigned to a computer graphics provider for fulfillment.

The various components of the system described herein may be implemented as a computer program using a general-purpose computer system. Such a computer system typically includes a main unit connected to both an output device that displays information to a user and an input device that receives input from a user. The main unit generally includes a processor connected to a memory system via an interconnection mechanism. The input device and output device also are connected to the processor and memory system via the interconnection mechanism.

One or more output devices may be connected to the computer system. Example output devices include, but are not limited to, liquid crystal displays (LCD), plasma displays, various stereoscopic displays including displays requiring viewer glasses and glasses-free displays, cathode ray tubes, video projection systems and other video output devices, printers, devices for communicating over a low or high bandwidth network, including network interface devices, cable modems, and storage devices such as disk or tape. One or more input devices may be connected to the computer system. Example input devices include, but are not limited to, a keyboard, keypad, track ball, mouse, pen and tablet, touchscreen, camera, communication device, and data input devices. The invention is not limited to the particular input or output devices used in combination with the computer system or to those described herein.

The computer system may be a general purpose computer system, which is programmable using a computer programming language, a scripting language or even assembly language. The computer system may also be specially programmed, special purpose hardware. In a general-purpose computer system, the processor is typically a commercially available processor. The general-purpose computer also typically has an operating system, which controls the execution of other computer programs and provides scheduling, debugging, input/output control, accounting, compilation, storage assignment, data management and memory management, and communication control and related services. The computer system may be connected to a local network and/or to a wide area network, such as the Internet. The connected network may transfer to and from the computer system program instructions for execution on the computer, media data such as video data, still image data, or audio data, metadata, review and approval information for a media composition, media annotations, and other data.

A memory system typically includes a computer readable medium. The medium may be volatile or nonvolatile, writeable or nonwriteable, and/or rewriteable or not rewriteable. A memory system typically stores data in binary form. Such data may define an application program to be executed by the microprocessor, or information stored on the disk to be processed by the application program. The invention is not limited to a particular memory system. Time-based media may be stored on and input from magnetic, optical, or solid state drives, which may include an array of local or network attached disks.

A system such as described herein may be implemented in software, hardware, firmware, or a combination of the three. The various elements of the system, either individually or in combination may be implemented as one or more computer program products in which computer program instructions are stored on a computer readable medium for execution by a computer, or transferred to a computer system via a connected local area or wide area network. Various steps of a process may be performed by a computer executing such computer program instructions. The computer system may be a multiprocessor computer system or may include multiple computers connected over a computer network. The components described herein may be separate modules of a computer program, or may be separate computer programs, which may be operable on separate computers. The data produced by these components may be stored in a memory system or transmitted between computer systems by means of various communication media such as carrier signals.

Having now described an example embodiment, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. A method of editing a time-based media composition comprising a media track, the method comprising:
running a first instance of a media composition software application having a user interface that includes a display of a timeline representation of the time-based media composition;
within the timeline, providing a track for defining and representing a plurality of timing blocks, wherein each timing block of the plurality of timing blocks is defined by a start time and an end time, and provides a container for media content of the time-based media composition that falls within a temporal span defined by the start time and the end time of the timing block; and
enabling a user of the first instance of the media composition software application to edit media content in a given timing block independently of media content in timing blocks of the plurality of timing blocks other than the given timing block.

2. The method of claim 1, wherein the timeline includes a plurality of media tracks, and the media content of the time-based media composition that falls within the temporal span of the timing block includes media within each of the plurality of media tracks.

3. The method of claim 1, wherein a given timing block of the plurality of timing blocks includes an audio track comprising a spoken passage of text, further comprising:
defining a time span of the given timing block based on a predetermined text reading rate.

4. The method of claim 1, wherein a time span of a given timing block of the plurality of timing blocks is defined prior to placing media content within a portion of the time-based media composition corresponding to the timing block.

5. The method of claim 1 further comprising:
running a second instance of the media composition software application; and
enabling a user of the second instance of the media composition software application to edit media content in a timing block other than the given timing block concurrently with the enablement of editing of the media composition in the given timing block by the first-mentioned user.

6. The method of claim 1, wherein a portion of the media composition corresponding to the given timing block is locked for editing by a user other than the first-mentioned user.

7. The method of claim 1 further comprising providing a graphical indication associated with a timing block as to whether a user other than the first-mentioned user has locked the timing block to prevent other users from editing the timing block.

8. The method of claim 6, wherein the graphical indication includes information on an identity of the user other than the first-mentioned user.

9. The method of claim 1 further comprising providing a graphical indication associated with a timing block as to whether the timing block has been approved by a participant in the editing of the media composition.

10. The method of claim 1 further comprising providing a graphical indication associated with a timing block as to whether the timing block includes empty space for which media content is lacking.

11. The method of claim 1 further comprising enabling the user to rearrange a temporal sequence of the plurality of timing blocks.

12. The method of claim 1, wherein a time span of a timing block of the plurality of timing blocks is automatically adjusted to conform to a time span of media content placed on a media track within the timing block.

13. The method of claim 1 further comprising enabling the user to adjust at least one of a start time and an end time of the given timing block.

14. A computer program product comprising:
a non-transitory computer-readable storage medium with computer program instructions encoded thereon, wherein the computer program instructions, when processed by a computer, instruct the computer to perform a method for editing a time-based media composition comprising a media track, the method comprising:
running a first instance of a media composition software application having a user interface that includes a display of a timeline representation of the time-based media composition;
within the timeline, providing a track for defining and representing a plurality of timing blocks, wherein each timing block of the plurality of timing blocks is defined by a start time and an end time, and provides a container for media content of the time-based media composition that falls within a temporal span defined by the start time and the end time of the timing block; and
enabling a user of the first instance of the media composition software application to edit media content in a given timing block independently of media content in timing blocks of the plurality of timing blocks other than the given timing block.

15. A system for editing a time-based media composition comprising a media track, the system comprising:
a memory for storing computer-readable instructions; and
a processor connected to the memory, wherein the processor, when executing the computer-readable instructions, causes the system to:
run a first instance of a media composition software application having a user interface that includes a display of a timeline representation of the time-based media composition;
within the timeline, provide a track for defining and representing a plurality of timing blocks, wherein each timing block of the plurality of timing blocks is defined by a start time and an end time, and provides a container for media content of the time-based media composition that falls within a temporal span defined by the start time and the end time of the timing block; and
enable a user of the first instance of the media composition software application to edit media content in a given timing block independently of media content in timing blocks of the plurality of timing blocks other than the given timing block.
